(19) United States
(12) Patent Application Publication
(10) Pub. No.: US 2025/0035448 A1
(43) Pub. Date: Jan. 30, 2025

(54) LOCALIZATION OF VECTORIZED HIGH DEFINITION (HD) MAP USING PREDICTED MAP INFORMATION

(71) Applicant: QUALCOMM Incorporated, San Diego, CA (US)

(72) Inventors: Heesoo MYEONG, Seoul (KR); Senthil Kumar YOGAMANI, Headford (IE); Varun RAVI KUMAR, San Diego, CA (US)

(21) Appl. No.: 18/360,615

(22) Filed: Jul. 27, 2023

(51) Int. Cl. G01C 21/32

(52) U.S. Cl. CPC G01C 21/32; B60W 60/001; B60W 2556/40

(57) ABSTRACT

Disclosed are techniques for localization of an object. For example, a device can generate, based on sensor data obtained from sensor(s) associated with an object, a predicted map comprising predicted nodes associated with a predicted location of the object within an environment. The device can receive a high definition (HD) map comprising HD nodes associated with a HD location of the object within the environment. The device can further match the predicted nodes with the HD nodes to determine pair(s) of matched nodes between the predicted map and the HD map. The device can determine, based on a comparison between nodes in each pair of the pair(s) of matched nodes, a respective node score for each pair of the pair(s) of matched nodes. The device can determine, based on the respective node score for each pair of the pair(s) of matched nodes, a location of the object within the environment.

### FIELD

Aspects of the present disclosure generally relate to localization of an object, such as a vehicle. For example, aspects of the present disclosure relate to localization of a vectorized high definition (HD) map using predicted map information (e.g., generated or determined using a machine learning system, such as a graph neural network).

### INTRODUCTION

Object localization can be used to identify a location of an object within an environment, such as by using an HD map of the environment. Object localization can be used in different fields including autonomous driving, security systems, robotics, aviation, among many others. Examples of fields where an object needs to be able to determine its location or position include autonomous driving by autonomous driving systems (e.g., of autonomous vehicles), autonomous navigation by a robotic system (e.g., an automated vacuum cleaner, an automated surgical device, etc.), aviation systems, among others. Using autonomous driving systems as an example, a critical requirement for autonomous driving is the ability of an autonomous vehicle to locate itself within an environment, such as on a road, and to accurately determine the location of the vehicle such that the vehicle can determine its location with respect to locations of other static objects within the environment and to determine the extent of drivable space on the road surrounding the vehicle.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for localization of an object. According to at least one illustrative example, an apparatus for localizing an object is provided. The apparatus includes at least one memory and at least one processor coupled to the at least one memory and configured to: generate, based on sensor data obtained from one or more sensors associated with the object, a predicted map comprising a plurality of predicted nodes associated with a predicted location of the object within an environment; receive a high definition (HD) map comprising a plurality of HD nodes associated with a HD location of the object within the environment; match at least one of the plurality of predicted nodes with at least one of the plurality of HD nodes to determine one or more pairs of matched nodes between the predicted map and the HD map; determine, based on a comparison between nodes in each pair of the one or more pairs of matched nodes, a respective node score for each pair of the one or more pairs of matched nodes; and determine, based on the respective node score for each pair of the one or more pairs of matched nodes, a location of the object within the environment.

In another illustrative example, a method of localizing an object is provided. The method includes: generating, based on sensor data obtained from one or more sensors associated with the object, a predicted map comprising a plurality of predicted nodes associated with a predicted location of the object within an environment; receiving a high definition (HD) map comprising a plurality of HD nodes associated with a HD location of the object within the environment; matching at least one of the plurality of predicted nodes with at least one of the plurality of HD nodes to determine one or more pairs of matched nodes between the predicted map and the HD map; determining, based on a comparison between nodes in each pair of the one or more pairs of matched nodes, a respective node score for each pair of the one or more pairs of matched nodes; and determining, based on the respective node score for each pair of the one or more pairs of matched nodes, a location of the object within the environment.

In another illustrative example, a non-transitory computer-readable storage medium is provided for localizing an object, non-transitory computer-readable storage medium including instructions stored thereon which, when executed by at least one processor, causes the at least one processor to: generate, based on sensor data obtained from one or more sensors associated with the object, a predicted map comprising a plurality of predicted nodes associated with a predicted location of the object within an environment; receive a high definition (HD) map comprising a plurality of HD nodes associated with a HD location of the object within the environment; match at least one of the plurality of predicted nodes with at least one of the plurality of HD nodes to determine one or more pairs of matched nodes between the predicted map and the HD map; determine, based on a comparison between nodes in each pair of the one or more pairs of matched nodes, a respective node score for each pair of the one or more pairs of matched nodes; and determine, based on the respective node score for each pair of the one or more pairs of matched nodes, a location of the object within the environment.

In another illustrative example, an apparatus for localizing an object is provided. The apparatus includes: means for generating, based on sensor data obtained from one or more sensors associated with the object, a predicted map comprising a plurality of predicted nodes associated with a predicted location of the object within an environment; means for receiving a high definition (HD) map comprising a plurality of HD nodes associated with a HD location of the object within the environment; means for matching at least one of the plurality of predicted nodes with at least one of the plurality of HD nodes to determine one or more pairs of matched nodes between the predicted map and the HD map; means for determining, based on a comparison between nodes in each pair of the one or more pairs of matched nodes, a respective node score for each pair of the one or more pairs of matched nodes; and means for determining, based on the respective node score for each pair of the one or more pairs of matched nodes, a location of the object within the environment.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a diagram illustrating an example of an environment including a road with static objects and a vehicle driving on the road, in accordance with some examples;

FIG. 2 is a diagram illustrating an example of a high definition (HD) map, in accordance with some examples;

FIG. 3 is a diagram illustrating an example of a system for localizing a vehicle using rasterized predictions, in accordance with some examples;

FIG. 4 is a diagram illustrating an example of an HD map including road lane information, in accordance with some examples;

FIG. 5 is a diagram illustrating an example of localizing a vehicle using rasterized predictions, in accordance with some examples;

FIG. 6 is a diagram illustrating an example of neural network matching system, in accordance with some examples;

FIG. 7 is a diagram illustrating an example of a rasterized representation of an environment and an example of a vectorized representation of the environment, in accordance with some examples;

FIG. 8 is a diagram illustrating an example of a process for generating a predicted map of an environment using sensor data, in accordance with some examples;

FIG. 9 is a diagram illustrating matching of predicted nodes from a predicted map of an environment with HD nodes from an HD map of the environment, in accordance with some examples;

FIG. 10 is a diagram illustrating examples of graphical representations of processes for hierarchical localization of an object, such as a vehicle, in accordance with some examples;

FIG. 11 is a table illustrating a comparison between processes for localizing an object within an environment using a rasterized representation of the environment verses using a vectorized representation of the environment, in accordance with some examples;

FIG. 12 is a block diagram illustrating an example of a deep learning network, in accordance with some examples;

FIG. 13 is a block diagram illustrating an example of a convolutional neural network, in accordance with some examples;

FIG. 14 is a flow diagram illustrating an example of a process for localization of an object, in accordance with some examples; and

FIG. 15 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

High definition (HD) maps are a fundamental component of many vehicles (e.g., autonomous and/or semi-autonomous vehicles) by encoding prior knowledge of all scenes (e.g., environment) an autonomous vehicle may encounter. An HD map may be three-dimensional (e.g., including elevation information). For instance, an HD map May include three-dimensional data (e.g., elevation data) regarding a three-dimensional space, such as a road on which a vehicle is navigating. In some examples, the HD map can include a plurality of map points corresponding to one or more reference locations in the three-dimensional space. In some cases, the HD map can include dimensional information for objects in the three-dimensional space and other semantic information associated with the three-dimensional space. For instance, the information from the HD map can include elevation or height information (e.g., road elevation/height), normal information (e.g., road normal), and/or other semantic information related to a portion (e.g., the road) of the three-dimensional space in which the vehicle is navigating.

An HD map may include a high level of detail (e.g., including centimeter level details). In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

For an autonomous vehicle to utilize HD maps, the vehicle must determine its own position (location) in relation to the HD map. An autonomous vehicle typically utilizes positioning sensors implemented onboard the vehicle to estimate a location of the vehicle. These positioning sensors can include satellite receivers (e.g., for satellite positioning systems) and inertial measurement units (IMUs).

Satellite positioning systems, such as global positioning system (GPS) or global navigation satellite system (GNSS), typically utilize triangulation of signals received from multiple satellites to determine the location of a satellite receiver (e.g., onboard an autonomous vehicle). Satellite positioning is generally inexpensive, but often has a positioning error of several meters, especially when the satellite receiver (vehicle) is within the presence of tall buildings and within tunnels. IMUs can calculate a vehicle's acceleration, angular velocity, and magnetic field to provide an estimate of the vehicle's relative motion. However, IMU sensor data can drift over time.

To overcome the limitations of these positioning sensors, place recognition techniques have been developed. These approaches store a representation of the environment in terms of geometry, such as light detection and ranging (LIDAR) point clouds; visual appearance, such as scale-invariant feature transform (SIFT) features and LIDAR intensity; and/or semantics, such as semantic point clouds, and formalize the localization as a retrieval task. Currently, existing research is based on rasterized representations, which use pixel-level correlations for inference, and do not make good use of structured context modeling information. As such, an improved technique for localization of an object, such as a vehicle, can be beneficial.

Systems, apparatuses, processes (also referred to as methods), and computer-readable media (collectively referred to as “systems and techniques”) are described herein for providing end to end hierarchical localization of a vectorized HD map using a graph neural network. In one or more examples, the systems and techniques utilize a graph-based representation for the localization system. This graph-based representation allows for observing matching and localization results change when inputting a variation of the graph representation of vectorized HD maps. In some examples, test cases can be synthesized by removing some connectivity from the graph, by changing the vertex sampling to dense, etc. from vectorized HD maps and/or predicted maps.

In one or more examples, the systems and techniques employ structured context modeling with a graph neural network to reduce the amount of heavy computation required when utilizing rasterized representations for localization. The structured context modeling with a graph neural network can perform a one-shot graph matching and global contextual-awareness computations using hierarchical scoring.

In one or more examples, an object (e.g., a vehicle, such as an autonomous vehicle) can generate, based on sensor data obtained from sensors (e.g., cameras, radar, and/or LIDAR) associated with the object, a predicted map including nodes (predicted nodes) associated with a location (a predicted location) of the object within an environment. In some examples, the object can receive (e.g., from a network entity, such as a network server) an HD map including nodes (HD nodes) associated with a location (an HD location) of the object within the environment. In one or more examples, the network entity can generate the HD map, based on positioning sensor data obtained from positioning sensors (e.g., GPS receivers, GNSS receivers, and/or IMUs) associated with the object. In some examples, the HD map can include vectorized representations of the environment.

In one or more examples, the vehicle can match (e.g., using a graph neural network) predicted nodes with HD nodes to determine pairs of matched nodes between the predicted map and the HD map. In some examples, the object can determine, based on a comparison between nodes in each pair of the matched nodes, a node score for each of the pairs of matched nodes. In one or more examples, the object can determine, based on the determined node scores, a location of the object within the environment.

In one or more examples, the predicted map can include polylines (predicted polylines), where each polyline can connect at least two of the predicted nodes. In some examples, the HD map can include polylines (HD polylines), where each HD polyline can connect at least two of the HD nodes. In one or more examples, the vehicle can determine a polyline score for each of the predicted polylines, based on the node scores of the matched pairs of nodes associated with the predicted polylines. In some examples, the vehicle can determine a polyline score for each of the HD polylines, based on the node scores of the matched pairs of nodes associated with the HD polylines. In one or more examples, the object can determine, based on the determined node scores and the polyline scores, a location of the object within the environment.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

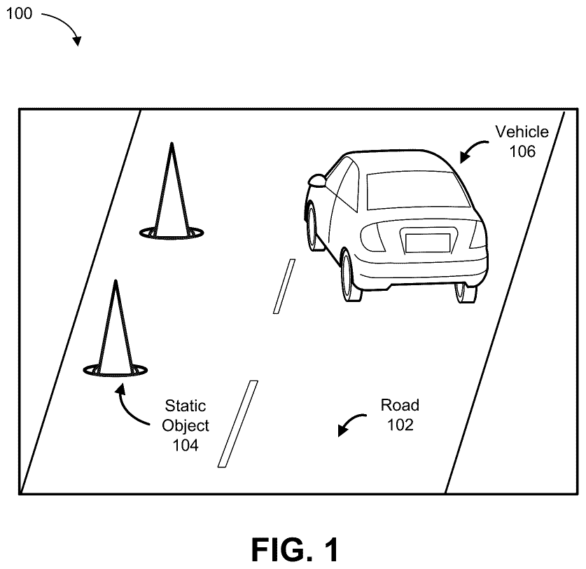

FIG. 1 is an example of an environment 100 including a road 102. The road 120 is shown to include objects (including as an example static object 104 in the form of a traffic cone) and a vehicle 106 driving on the road 102. The vehicle 106 is an example of a dynamic object. In one or more examples, the vehicle 106 can be equipped with certain sensors, such as cameras (e.g., an image capturing device), radar (e.g., including an RF frequency antenna, transmitter, and/or receiver), and/or light-based sensors (e.g., a time-of-flight sensor, such as a light detection and ranging (LIDAR) sensor). These sensors can obtain sensor data related to the environment 100 surrounding the vehicle 106. The vehicle 106 can use this sensor data to generate a predicted map of the environment 100 including a predicted location of the vehicle 106 with respect to the road 102 and the objects (e.g., static objects and/or mobile objects) located on or nearby the road 102.

In some examples, the vehicle 106 can be equipped with positioning sensors, such as satellite receivers (e.g., a global positioning system (GPS) receiver and/or a global navigation satellite system (GNSS) receiver) and/or inertial measurement units (IMUs). These positioning sensors can obtain positioning sensor data related to the environment 100 surrounding the vehicle 106. The vehicle 106 can send (e.g., wirelessly transmit) the obtained positioning sensor data to a network entity (e.g., a network server) for processing. The network entity can process the received positioning sensor data from the vehicle 106 along with other data associated with the environment 100 (e.g., positioning sensor data received from other vehicles and/or network devices located within or nearby the environment 100) to generate a high definition (HD) map of the environment 100. The HD map can include a location (e.g., an HD location) of the vehicle 106 with respect to the road 102 and the objects (e.g., static objects and/or mobile objects) located on or nearby the road 102.

In one or more examples, the vehicle 106 can be an autonomous vehicle operating at a particular autonomy level. The ability for the vehicle 106 to be able to localize itself can be especially important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions such as drive in a straight path, stay in a particular lane, control the distance from other vehicles in front of the vehicle, or other functions. Autonomy levels 3, 4, and 5 include more autonomy than levels 1 and 2. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain at the in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles full autonomous, self-driving vehicles that operate autonomously in all conditions. A human operator is not needed for the vehicle to take any action.

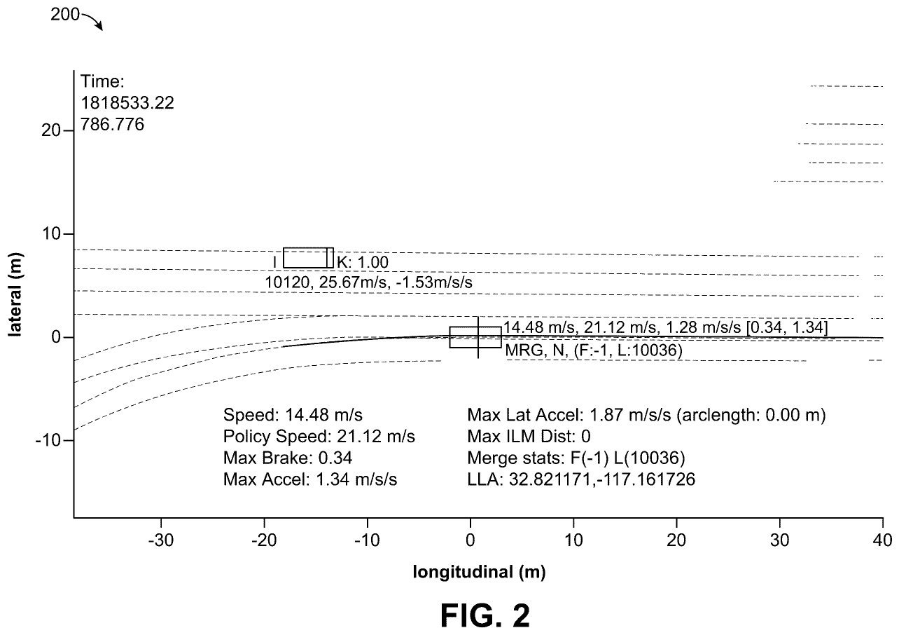

As previously mentioned, HD maps are a fundamental component of most autonomous vehicles by encoding prior knowledge of all scenes (e.g., environment) an autonomous vehicle may encounter. Advanced driver assistance systems and automated driving (AD) of autonomous vehicles require localization of the vehicle. For an autonomous vehicle to exploit HD maps, the vehicle needs to determine its own position (location) in relation to the HD map. FIG. 2 shows an example of an HD map 200. In the HD map 200, the x-axis represents longitudinal distance in meters (m), and the y-axis represent latitudinal distance in m. In FIG. 2, the HD map 200 is shown to include a vehicle (e.g., located at 0,0), such as an autonomous vehicle, within an environment, which includes roads and another vehicle (e.g., located on −15, 5).

An autonomous vehicle generally utilizes positioning sensors onboard the vehicle to estimate a location (position) of the vehicle. These positioning sensors may include, but are not limited to, satellite receivers (e.g., for satellite positioning systems) and inertial measurement units (IMUs). Satellite positioning systems (e.g., GPS, GNSS, etc.) exploit triangulation of signals received from multiple satellites to determine the location of a satellite receiver (e.g., located on an autonomous vehicle). Satellite positioning is affordable, but often has large positioning errors (e.g., errors of several meters), especially when the satellite receiver (vehicle) is located within the presence of tall buildings or within tunnels. IMUs can calculate the acceleration, angular velocity, and magnetic field of a vehicle to provide an estimate of the relative motion of the vehicle. IMU sensor data can, however, drift over time.

To overcome the limitations of these positioning sensors, place recognition techniques have been developed. These approaches store a representation of the environment in terms of geometry (e.g., LIDAR point clouds), visual appearance (e.g., SIFT features and LIDAR intensity), and/or semantics (e.g., semantic point clouds), and formalize the localization as a retrieval task.

Recently, researchers have exploited vehicle dynamics as well as semantic maps containing lane graphs with the locations of traffic signs. However, this research has been based on pixel level correlation between rasterized predictions and HD map, and does not make good use of context modeling information. It can be difficult to consider the correlation when using complex topological information (e.g., urban scenarios).

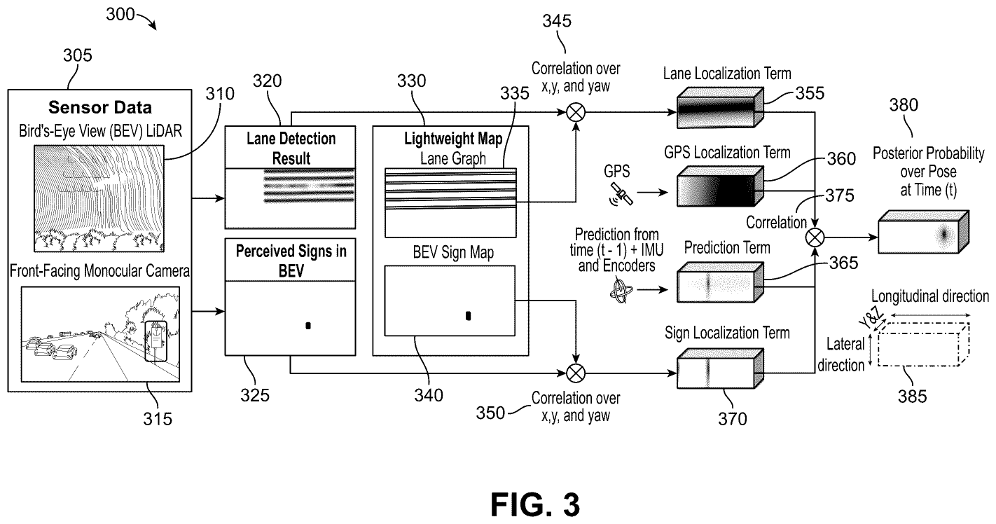

FIG. 3 shows an example of this recent research using rasterized predictions. In particular, FIG. 3 is a diagram illustrating an example of a system 300 for localizing a vehicle using rasterized predictions. In FIG. 3, the system 300 is shown to include sensor data 305, a lane detection result 320, perceived signs in a bird's eye view (BEV) 325, a lightweight map 330, multiplexers 345, 350, 375, a lane localization term 355, a GPS localization term 360 (which can be a GNSS or other satellite positioning term in other case), a prediction term 365, a sign localization term 370, a posterior probability over post at time (t) 380, and a block depiction of a pose of the vehicle 385. The front-facing monocular camera data 315 shows an image including a sign (e.g., denoted by a box), which can be used for the localization of the vehicle. Pixels of the sign can be unprojected from three-dimensions (3D) and rasterized (e.g., in the perceived signs in BEV 325). The sensor data 350 includes BEV LIDAR data 310 and front-facing monocular camera data 315. The lightweight map 330 can build sparse HD maps containing just the lane graph 335 and the locations of the traffic signs (e.g., BEV sign map 340).

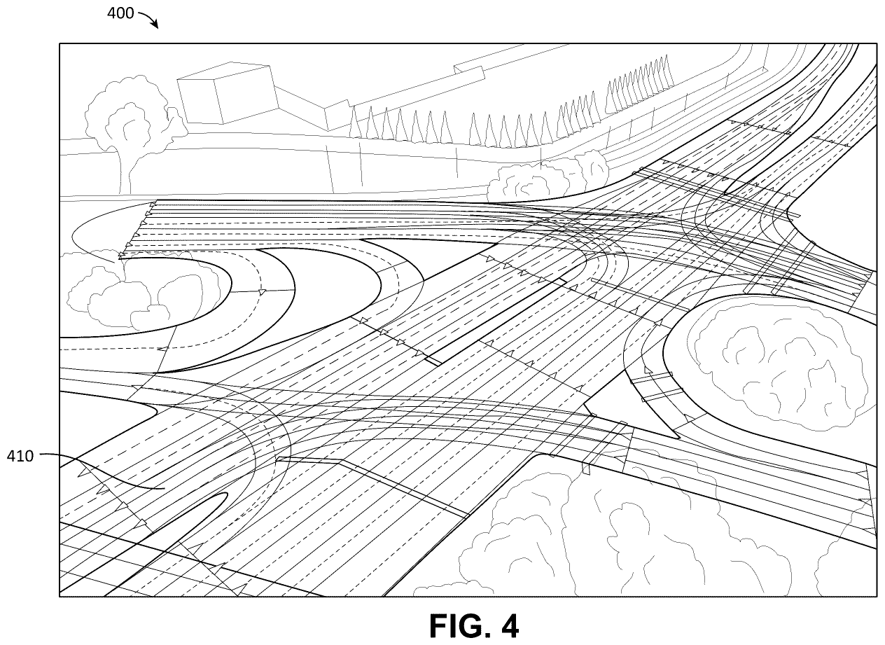

The system 300 of FIG. 3 provides a lightweight localization method that exploits vehicle dynamics as well as a semantic map containing lane graphs and the locations of traffic signs to localize the vehicle. FIG. 4 shows an example of a semantic map of an environment in the form of an HD map 400 including road lanes 410 and traffic signs.

In FIG. 3, given the camera information (e.g., front-facing monocular camera data 315) and the LIDAR data (e.g., BEV LIDAR data 310) as an input to the system 300, lanes can be detected in the form of a truncated inverse distance transform (e.g., as shown in the lane detection result 320) and signs can be detected as a BEV probability map (e.g., as shown in the perceived signs in BEV 325). The detection output can then be passed through a differentiable rigid transform layer under multiple rotational angles.

An inner product score can be measured between the inferred semantics (e.g., lane detection result 320 and perceived signs in BEV 325) and the map (e.g., lightweight map 335). The probability score can be merged with GPS or GNSS (e.g., GPS location term 360) and vehicle dynamic observations (e.g., prediction term 365). The inferred pose (e.g., pose of the vehicle 385) can be computed from the posterior (e.g., posterior probability over pose at time (t) 380) using soft arguments of the maxima (argmax).

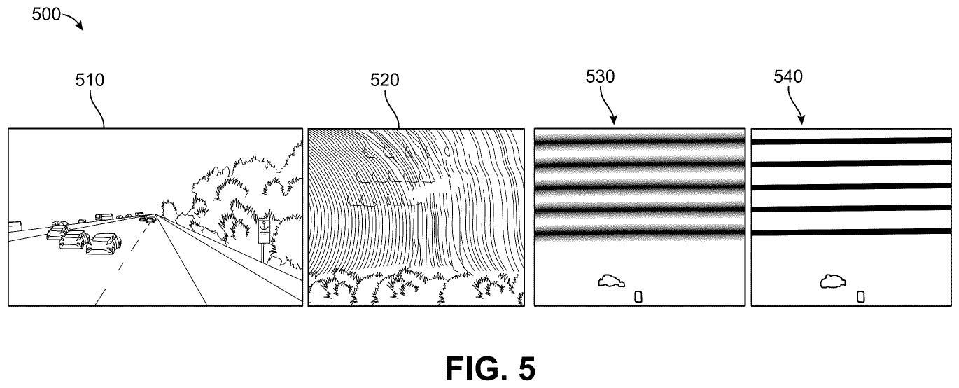

FIG. 5 shows an example of localizing the vehicle using the system 300. In particular, FIG. 5 is a diagram 500 illustrating an example of localizing a vehicle using rasterized predictions. The system 300 can detect signs in the camera image 510 (e.g., sign in front-facing monocular camera data 315) and project the sign's points in a top-down view (e.g., perceived signs in BEV 325) using LIDAR data 520 (e.g., BEV LIDAR data 310). The system 300 can use this result (e.g., perceived signs in BEV 325) in conjunction with the lane detection result 530 (e.g., lane detection result 32) to localize against the lightweight map 330 including just signs (e.g., BEV sign map 340) and boundaries 540 (e.g., lane graph 335). The system 300 can obtain the probability of a vehicle to be located at a given location by performing cross-correlation between the two rasterized prediction maps (e.g., BEV sign map 340 and land graph 335) and the HD map (e.g., lane detection result 320 and perceived signs in BEV 325).

However, as previously mentioned above, this existing research (e.g., system 300) is based on rasterized representations, which use pixel-level correlations for inference, and do not make good use of structured context modeling information. As such, an improved technique for localization of an object, such as a vehicle, can be useful.

In one or more examples, the disclosed systems and techniques provide end to end hierarchical localization of a vectorized (not rasterized) HD map using a graph neural network. The systems and techniques employ a graph neural network with vectorized HD maps and predicted online HD map inference results to perform accurate localization of an object, considering the structure semantic topology between them.

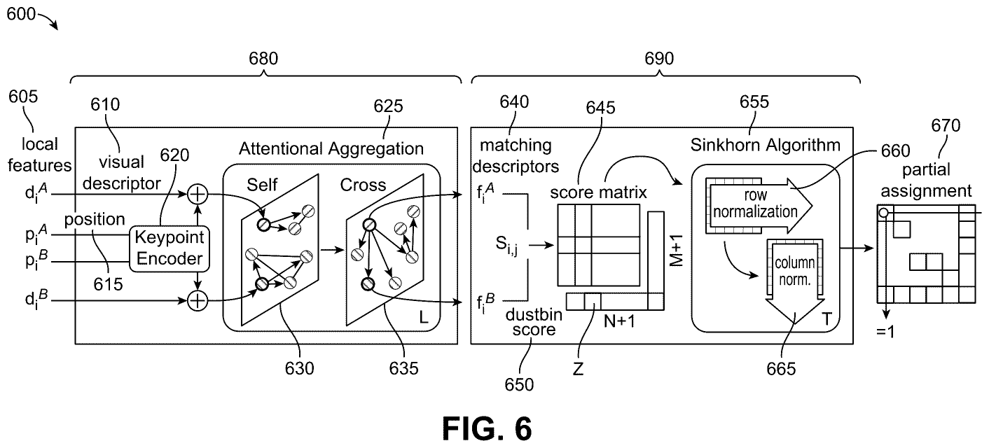

FIG. 6 shows an example of a graph neural network that may be employed by the disclosed systems and techniques for the localization of an object. In particular, FIG. 6 is a diagram illustrating an example of neural network matching system 600 (e.g., which may be referred to as a superglue matching system). In FIG. 6, the system 600 is shown to include two portions, which include an attention graph neural network 680 (e.g., which encodes contextual cues and priors) and an optimal matching layer 690 (e.g., a differentiable solver). Visual descriptors (di) 610 and positions (pi) 615 for nodes (e.g., associated with possible locations for an object) can be inputted into the attention graph neural network 680. The attention graph neural network 680 includes local features 605, visual descriptors (di) 610, positions (pi) 615, a keypoint encoder 620, and an attentional aggregation 625. The optimal matching layer 690 includes matching descriptors 640, a score matrix 645, a dustbin score 650, the Sinkhorn algorithm 655, row normalization 660, column normalization 655, and a partial assignment 670.

The attention graph neural network 680 of the system 600 can use the keypoint encoder 620 to map keypoint positions 615 (pi) and their visual descriptors 610 (di) into a single vector. The attention graph neural network 680 can then use alternating self-attention 630 and cross-attention 635 layers (e.g., repeated L number of times) to create stronger representations of the matching descriptors (f) 640. The optimal matching layer can create an M by N score matrix 645, augment it with dustbin scores 650, and then determine the optimal partial assignment 670 using the Sinkhorn algorithm 655 (e.g., for T number of iterations).

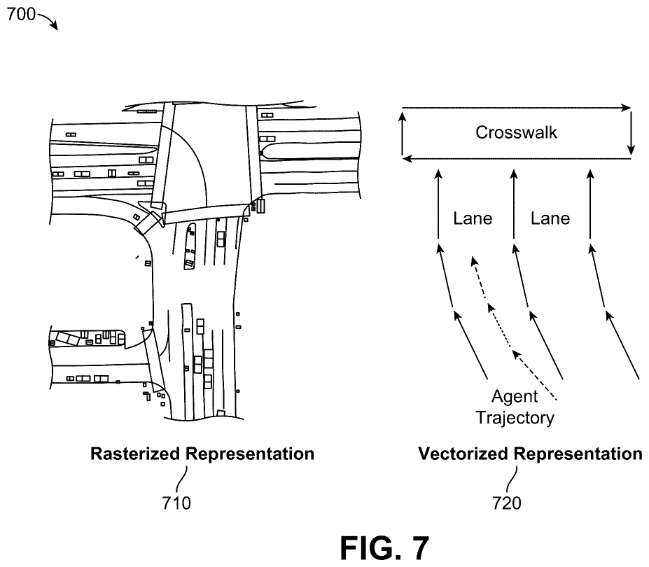

As previously mentioned, the systems and techniques utilize vectorized (not rasterized) HD maps for localization of an object. The use of vectorized HD maps for the localization avoids lossy rendering and computationally intensive encoding. FIG. 7 shows an example of an environment depicted using a rasterized representation and a vectorized representation. In particular, FIG. 7 is a diagram 700 illustrating an example of a rasterized representation 710 of an environment and an example of a vectorized representation 720 of the environment. FIG. 7 shows the rasterized rendering and the vectorized approach to represent an HD map and agent trajectories.

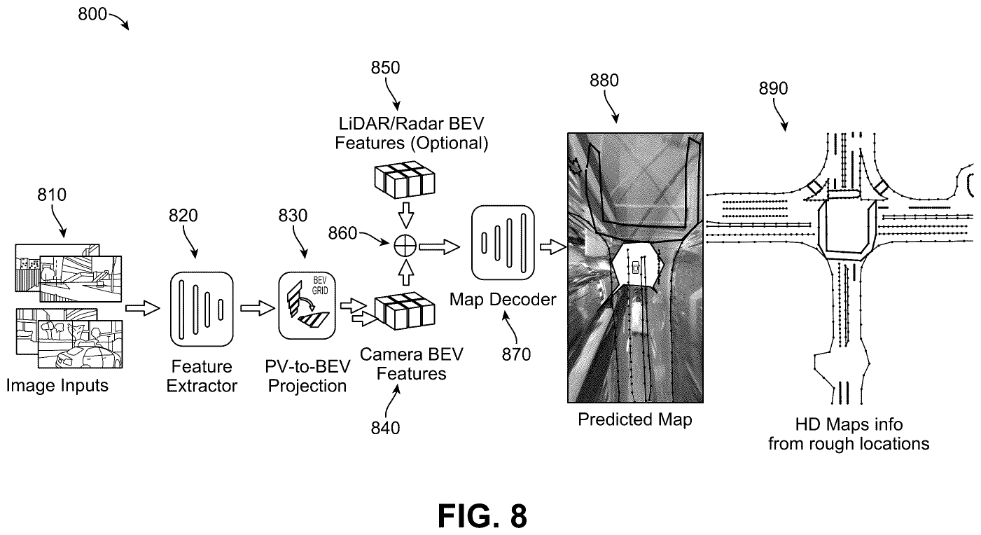

In one or more aspects, the systems and techniques utilize two different types of maps of an environment for the localization of an object within the environment. The two different types of maps are a vectorized HD map and a predicted map. In one or more examples, the systems and techniques provide a process for generating the predicted map. FIG. 8 shows an example of the process for generating the predicted map. In particular. FIG. 8 is a diagram illustrating an example of a process 800 for generating a predicted map of an environment of an object using sensor data.

During operation of the process 800 of FIG. 8, sensors (e.g., cameras) associated with (e.g., onboard) the object (e.g., vehicle) can obtain (capture) sensor data (e.g., images 810) of the environment of the object (e.g., obtained at a specific timestamp). A feature extractor 820 can extract features within the environment from the sensor data (e.g., images 810). Then, a prospective view (PV) of the images 810 can be projected onto a BEV (e.g., a PV to BEV projection 830 can be performed).

Other sensors (e.g., radar and/or LIDAR sensors) associated with (e.g., onboard) the object (e.g., vehicle) can obtain sensor data (e.g., radar data and/or LIDAR data) of the environment of the object (e.g., obtained at the same time (timestamp) that the images 810 were captured). LIDAR BEV features and/or radar BEV features can be extracted from the sensor data (e.g., radar data and/or LIDAR data). Optionally, the camera BEV features 840 can be combined (e.g., via a multiplexer 860) with LIDAR and/or radar BEV features 850.

A map decoder 870 can then use the features (e.g., the camera BEV features 840, the LIDAR BEV features 850, and/or the radar BEV features 850) to generate the predicted map 880 (e.g., predicted online HD map). The predicted map 880 includes multiple polylines. Each of the polylines has a class, such as a divider, road boundary, etc. Each of the polylines is composed of one or more connected straight-line segments, which together form a shape. Each polyline may include two or more nodes. Each node can represent a possible location for the object.

FIG. 8 also shows an example of an HD map 890. Similar to the predicted map 880, the HD map 890 includes multiple polylines, which each include two or more nodes. HD maps potentially have inaccurate location information that was obtained from sensor information of different modalities, such as satellite receivers (e.g., GPS receivers, GNSS receivers, etc.) and IMUs.

In one or more aspects, an object (e.g., a vehicle) can localize itself (e.g., the object) within an environment by using a predicted map and an HD map of the environment. In one or more examples, for the localization of an object, the object (e.g., vehicle) can match nodes (predicted nodes) from the predicted map 880 with nodes (HD nodes) from the HD map 890 to form pairs of nodes (e.g., pairs of matched nodes). For example, the object (e.g., vehicle) can form a pair of matched nodes including one predicted node from the predicted map 880 and one HD node from the HD map 890. When the predicted map 880 is compared (e.g., overlaid) with the HD map 890, the predicted node matched with the HD node should be overlapping with each other or in close proximity with each other with respect to their location within the environment.

In one or more examples, the object (e.g., vehicle) can utilize machine learning (ML) for the matching of the nodes to form the pairs of matched nodes. In one or more examples, the object (e.g., vehicle) can employ a graph neural network to perform the machine learning. In some examples, the neural network matching system 600 (e.g., the superglue matching system) of FIG. 6 may be employed for the graph neural network. In one or more examples, other different types of machine learning and graph neural networks, other than the neural network matching system 600, may be employed for the graph neural network to perform the matching of the nodes.

In one or more aspects, for the matching of the nodes to form pairs of matched nodes, visual descriptors (di) 610 and positions (pi) 615 for the nodes (e.g., including predicted nodes and HD nodes) need to be determined. The visual descriptors (di) 610 and positions (pi) 615 for the nodes can then be utilized by machine learning to determine the pairs of the matched nodes. For example, the visual descriptors (di) 610 and positions (pi) 615 for the nodes may be inputted into the neural network matching system 600 of FIG. 6 to determine the pairs of the matched nodes.

In one or more examples, predicted map 880 (e.g., map A) can have M number of polylines, and HD map 890 (e.g., map B) can have N number of polylines. Every point (e.g. which maps to a node for a graph representation) in a polyline and confidence pᵢ: [x₀, y₀, cₘ) . . . (x_{K}_{ₘ}, y_{K}_{ₘ}, cₘ)]_{m=1, . . . , M}, [x₀, y₀, cₙ) . . . (x_{K}_{ₙ}, y_{K}_{ₙ}, cₙ)]_{n=1, . . . N}

The (x,y) points in map A (e.g., HD map 890) are each the relative distance from the object (e.g., vehicle), and the (x,y) points in map B (e.g., predicted map 880) are each the relative distance from a location obtained from sensor data. The x, y are coordinates of each node, and the c represents a prediction score for the node. The prediction score is the probability that the location of the node is an accurate location for the object. The rasterized visual descriptor for every point is di, and the total number of nodes is (K₀+ . . . +K_{M}). (K₀+ . . . +K_{N}).

After the machine learning (e.g., graph neural network) has processed the visual descriptors (di) 610 and positions (pi) 615 for the nodes, the machine learning can output partial assignments (e.g., partial assignments 670 of FIG. 6). Each partial assignment is for single pair of matched nodes (e.g., which may take into consideration any occlusion interference and/or noise). A example soft partial assignment is:

$$P ∈ {[ 0 , 1 ]}^{( {K}_{0} + .. + {K}_{M} ) \times ( {K}_{0} + .. + {K}_{N} )}$$

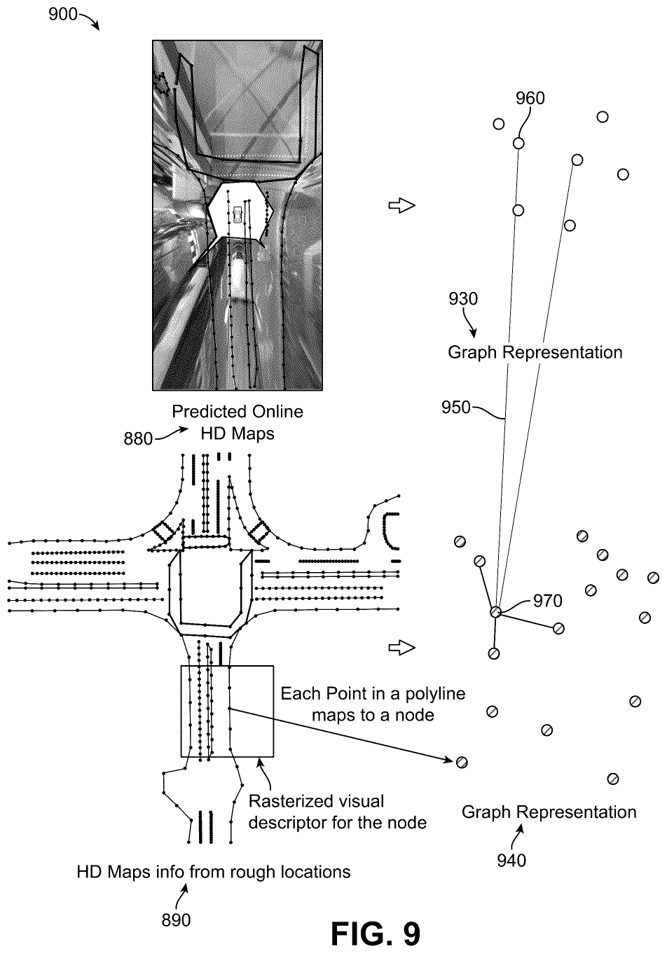

FIG. 9 shows an example of matching nodes to form pairs of matched nodes. In particular, FIG. 9 is a diagram illustrating matching of nodes (predicted nodes) from a predicted map 880 of an environment with nodes (HD nodes) from an HD map 890 of the environment. FIG. 9 shows a graph representation 930 of predicted nodes (e.g., including predicted node 960) for the predicted map 800, and a graph representation 940 of HD nodes (e.g., HD node 970) for the HD map 890. As shown in FIG. 9, predicted node 960 is matched with HD node 970 to form a pair of matched nodes. A polyline 950 is shown to be formed between the nodes (e.g., predicted node 950 and HD node 970) of the pair of matched nodes.

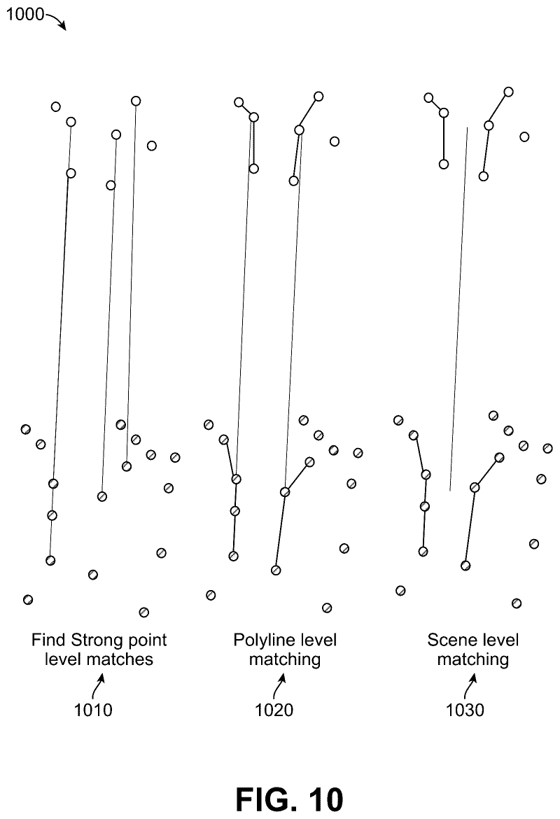

In one or more aspects, the systems and techniques can perform hierarchical localization of an object (e.g., after the nodes are matched into pairs of matched nodes). FIG. 10 is a diagram illustrating examples of graphical representations of processes for hierarchical localization of an object. In FIG. 10, a graphical representation of a process for finding strong point level matches 1010, a graphical representation of a process for polyline level matching, and a graphical representation of a process for scene level matching are shown.

In one or more aspects, scores (e.g., probabilities of accuracy) can be assigned to each pair of matched nodes. The object (e.g., vehicle) can use the scores of the pairs of the matched nodes to determine the location of the object. In one or more examples, point level matching may be performed to determine the location of the object. For example, in a soft assignment, a strong match can be determined when a score of a pair of matched nodes is above a certain score threshold (e.g., a predetermined threshold for the score, probability). The location of the object (e.g., ego pose) can be updated (determined) by averaging the displacement between each (x,y) point between matches.

In one or more aspects, scores (e.g., probabilities of accuracy) can be assigned to polylines (referred to as a polyline score) that are formed between the two nodes of a pair of matched nodes. The object (e.g., vehicle) can use the scores of the polylines (e.g., along with the scores of the nodes) to determine the location of the object. In one or more examples, polyline level matching may be performed to determine the location of the object. Both the predicted map and the HD map can have connectivity between points (nodes), the score between the matched nodes can be used to predict the score between polylines (e.g., by averaging the match scores between the points (nodes) inside the polylines). The location of the object (e.g., ego pose) can be updated (determined) by averaging the displacement between each polylines.

In one more aspects, scene level matching can be performed to determine the location of the object. Similar to using scores of polylines to determine the location of the object, scores of scene levels can be used to determine the location of the object.

In one or more examples, the all matching scores (e.g., node scores, polyline scores, and/or scene scores that are associated with each other) can be combined into one score. Hierarchical matching from point (node) to polyline to scene level can be performed by propagating scores from one level to next. The location of the object (e.g., ego pose) can be updated based on a hierarchical displacement estimation.

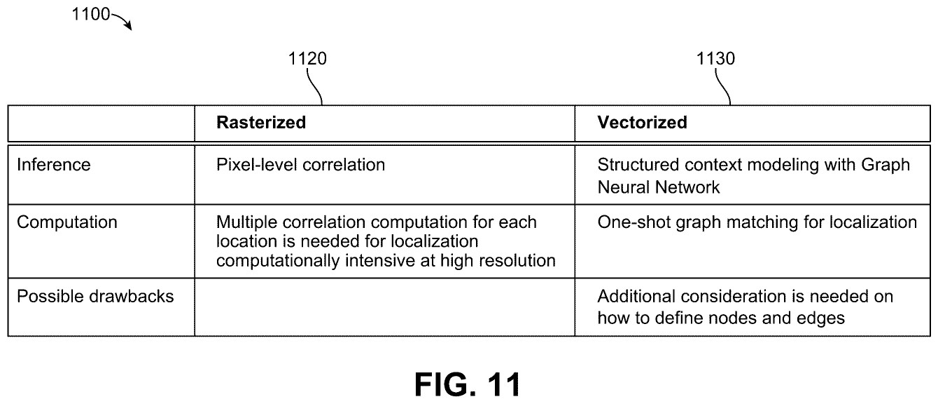

As previously mentioned, the systems and techniques, unlike prior systems (e.g., system 300 for localizing a vehicle), utilize vectorized (not rasterized) HD maps for localization of an object. FIG. 11 shows a table showing a comparison of processes for localizing an object using rasterized representations versus processes for localizing an object using vectorized representations. In particular, FIG. 11 is a table 1100 illustrating a comparison between processes for localizing an object within an environment using a rasterized representation of the environment verses using a vectorized representation of the environment. In FIG. 11, the table 1100 is shown to include a processes that use rasterized representations column 1120 and a processes that use vectorized representations column 1130. As shown in the table 1100, processes that use rasterized representations use a pixel-level correlation and, conversely, processes that use vectorized representations use a structured context modeling with a graph neural network. The table 1100 also shows that for processes that use rasterized representations, multiple correlation computation for each location is needed for localization and, as such, these processes are computationally intensive at high resolutions. The table 1100 shows that, conversely, processes that use vectorized representations use one-shot graph matching for localization, which are not very computationally intensive because it is a one-shot matching. The table 1100 also shows that processes using vectorized representations have a possible drawback of needing an additional consideration regarding how to define nodes and edges (polylines).

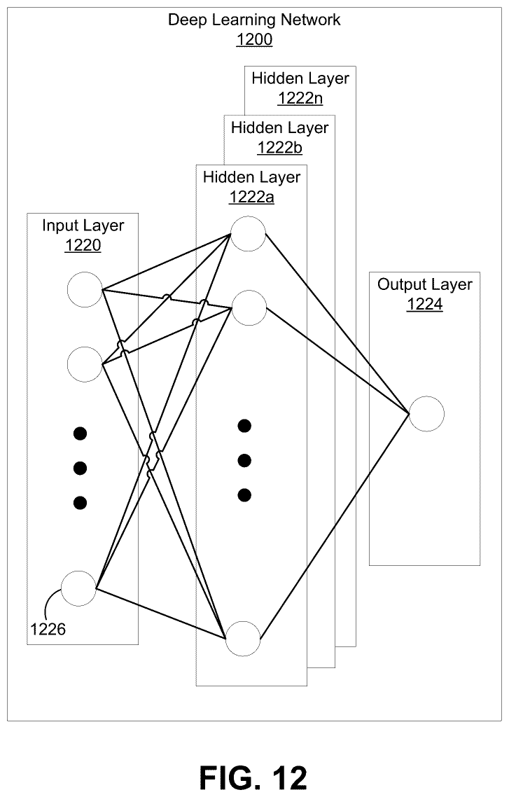

FIG. 12 is an illustrative example of a deep learning neural network 1200 that can be used for matching nodes in a predicted map with nodes in an HD map. An input layer 1220 includes input data. In one illustrative example, the input layer 1220 can include data representing the pixels of an input image or video frame. The neural network 1200 includes multiple hidden layers 1222a. 1222b, through 1222n. The hidden layers 1222a, 1222b, through 1222n include “n” number of hidden layers, where “n” is an integer greater than or equal to one. The number of hidden layers can be made to include as many layers as needed for the given application. The neural network 1200 further includes an output layer 1224 that provides an output resulting from the processing performed by the hidden layers 1222a, 1222b, through 1222n. In one illustrative example, the output layer 1224 can provide a classification for an object in an input image or video frame. The classification can include a class identifying the type of object (e.g., a static object, a vehicle, a person, a dog, a cat, or other object).

The neural network 1200 is a multi-layer neural network of interconnected nodes. Each node can represent a piece of information. Information associated with the nodes is shared among the different layers and each layer retains information as information is processed. In some cases, the neural network 1200 can include a feed-forward network, in which case there are no feedback connections where outputs of the network are fed back into itself. In some cases, the neural network 1200 can include a recurrent neural network, which can have loops that allow information to be carried across nodes while reading in input.

Information can be exchanged between nodes through node-to-node interconnections between the various layers. Nodes of the input layer 1220 can activate a set of nodes in the first hidden layer 1222a. For example, as shown, each of the input nodes of the input layer 1220 is connected to each of the nodes of the first hidden layer 1222a. The nodes of the hidden layers 1222a, 1222b, through 1222n can transform the information of each input node by applying activation functions to the information. The information derived from the transformation can then be passed to and can activate the nodes of the next hidden layer 1222b, which can perform their own designated functions. Example functions include convolutional, up-sampling, data transformation, and/or any other suitable functions. The output of the hidden layer 1222b can then activate nodes of the next hidden layer, and so on. The output of the last hidden layer 1222n can activate one or more nodes of the output layer 1224, at which an output is provided. In some cases, while nodes (e.g., node 1226) in the neural network 1200 are shown as having multiple output lines, a node has a single output and all lines shown as being output from a node represent the same output value.

In some cases, each node or interconnection between nodes can have a weight that is a set of parameters derived from the training of the neural network 1200. Once the neural network 1200 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1200 to be adaptive to inputs and able to learn as more and more data is processed.

The neural network 1200 is pre-trained to process the features from the data in the input layer 1220 using the different hidden layers 1222a. 1222b, through 1222n in order to provide the output through the output layer 1224. In an example in which the neural network 1200 is used to identify objects in images, the neural network 1200 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 1200 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1200 is trained well enough so that the weights of the layers are accurately tuned.

For the example of identifying objects in images, the forward pass can include passing a training image through the neural network 1200. The weights are initially randomized before the neural network 1200 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 1200, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1200 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1200 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

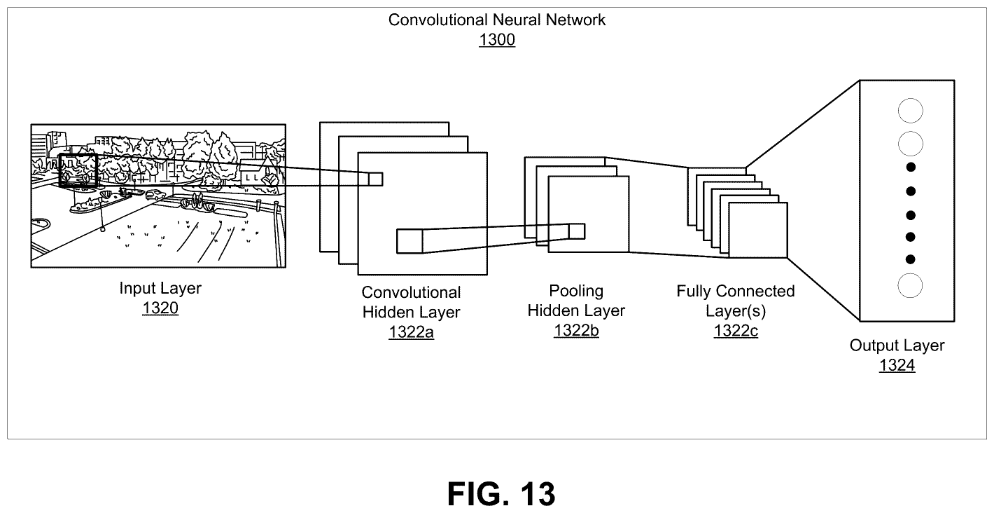

The neural network 1200 can include any suitable deep network. One example includes a convolutional neural network (CNN), which includes an input layer and an output layer, with multiple hidden layers between the input and out layers. An example of a CNN is described below with respect to FIG. 13. The hidden layers of a CNN include a series of convolutional, nonlinear, pooling (for downsampling), and fully connected layers. The neural network 1200 can include any other deep network other than a CNN, such as an autoencoder, a deep belief nets (DBNs), a Recurrent Neural Networks (RNNs), among others.

FIG. 13 is an illustrative example of a convolutional neural network 1300 (CNN 1300). The input layer 1320 of the CNN 1300 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1322a, an optional non-linear activation layer, a pooling hidden layer 1322b, and fully connected hidden layers 1322c to get an output at the output layer 1324. While only one of each hidden layer is shown in FIG. 13, one of ordinary skill will appreciate that multiple convolutional hidden layers, non-linear layers, pooling hidden layers, and/or fully connected layers can be included in the CNN 1300. As previously described, the output can indicate a single class of an object or can include a probability of classes that best describe the object in the image.

The first layer of the CNN 1300 is the convolutional hidden layer 1322a. The convolutional hidden layer 1322a analyzes the image data of the input layer 1320. Each node of the convolutional hidden layer 1322a is connected to a region of nodes (pixels) of the input image called a receptive field. The convolutional hidden layer 1322a can be considered as one or more filters (each filter corresponding to a different activation or feature map), with each convolutional iteration of a filter being a node or neuron of the convolutional hidden layer 1322a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1322a. Each connection between a node and a receptive field for that node learns a weight and, in some cases, an overall bias such that each node learns to analyze its particular local receptive field in the input image. Each node of the hidden layer 1322a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 1322a is due to each node of the convolutional layer being applied to its corresponding receptive field. For example, a filter of the convolutional hidden layer 1322a can begin in the top-left corner of the input image array and can convolve around the input image. As noted above, each convolutional iteration of the filter can be considered a node or neuron of the convolutional hidden layer 1322a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1322a. For example, a filter can be moved by a step amount to the next receptive field. The step amount can be set to 1 or any other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1322a.

The mapping from the input layer to the convolutional hidden layer 1322a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1322a can include several activation maps in order to identify multiple features in an image. The example shown in FIG. 13 includes three activation maps. Using three activation maps, the convolutional hidden layer 1322a can detect three different kinds of features, with each feature being detectable across the entire image.

In some examples, a non-linear hidden layer can be applied after the convolutional hidden layer 1322a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1300 without affecting the receptive fields of the convolutional hidden layer 1322a.

The pooling hidden layer 1322b can be applied after the convolutional hidden layer 1322a (and after the non-linear hidden layer when used). The pooling hidden layer 1322b is used to simplify the information in the output from the convolutional hidden layer 1322a. For example, the pooling hidden layer 1322b can take each activation map output from the convolutional hidden layer 1322a and generates a condensed activation map (or feature map) using a pooling function. Max-pooling is one example of a function performed by a pooling hidden layer. Other forms of pooling functions be used by the pooling hidden layer 1322a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1322a. In the example shown in FIG. 13, three pooling filters are used for the three activation maps in the convolutional hidden layer 1322a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1322a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1322a having a dimension of 24×24 nodes, the output from the pooling hidden layer 1322b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1300.

The final layer of connections in the network is a fully-connected layer that connects every node from the pooling hidden layer 1322b to every one of the output nodes in the output layer 1324. Using the example above, the input layer includes 28×28 nodes encoding the pixel intensities of the input image, the convolutional hidden layer 1322a includes 3×24×24 hidden feature nodes based on application of a 5×5 local receptive field (for the filters) to three activation maps, and the pooling layer 1322b includes a layer of 3×12×12 hidden feature nodes based on application of max-pooling filter to 2×2 regions across each of the three feature maps. Extending this example, the output layer 1324 can include ten output nodes. In such an example, every node of the 3×12×12 pooling hidden layer 1322b is connected to every node of the output layer 1324.

The fully connected layer 1322c can obtain the output of the previous pooling layer 1322b (which should represent the activation maps of high-level features) and determines the features that most correlate to a particular class. For example, the fully connected layer 1322c layer can determine the high-level features that most strongly correlate to a particular class and can include weights (nodes) for the high-level features. A product can be computed between the weights of the fully connected layer 1322c and the pooling hidden layer 1322b to obtain probabilities for the different classes. For example, if the CNN 1300 is being used to predict that an object in an image or video frame is a vehicle, high values will be present in the activation maps that represent high-level features of vehicles (e.g., two or four tires, a windshield, side view mirrors, etc.).

In some examples, the output from the output layer 1324 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 00 0 0], the vector indicates that there is a 5% probability that the image is the third class of object (e.g., a person), an 80% probability that the image is the fourth class of object (e.g., a static object on a road or other driving surface), and a 15% probability that the image is the sixth class of object (e.g., a vehicle). The probability for a class can be considered a confidence level that the object is part of that class.

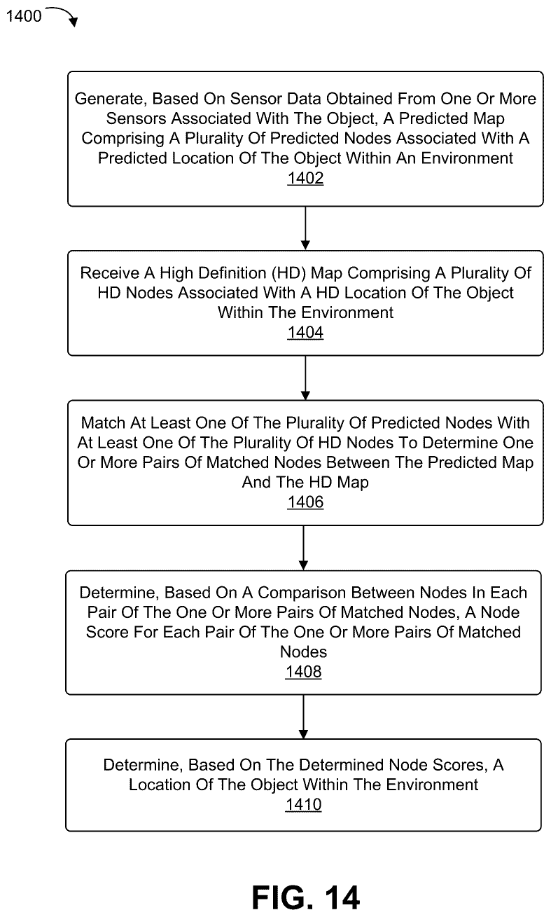

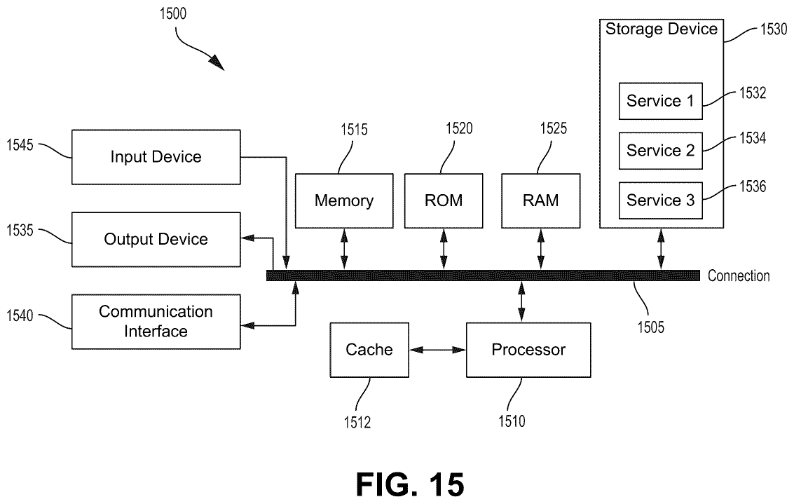

FIG. 14 is a flow chart illustrating an example of a process 1400 for localization of an object, such as a vehicle (e.g., an autonomous vehicle). One or more operations of process 1400 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, or other type of computing device. For instance, the computing device can be part of the object (e.g., a computing system or component of a vehicle). The one or more operations of process 1400 may be implemented as software components that are executed and run on one or more processors (e.g., processor 1510 of FIG. 15 or other processor(s)). Further, the transmission and reception of signals by the computing device in the process 1400 may be enabled, for example, by one or more antennas and/or one or more transceivers such as one or more wireless transceivers (e.g., one or more of the receivers, transmitters, and/or transceivers, the communication interface 1540 of FIG. 15, and/or other antenna and/or transceiver).

At block 1402, the computing device (or component thereof) can generate, based on sensor data obtained from one or more sensors associated with the object, a predicted map (e.g., predicted map 880 of FIG. 8) including a plurality of predicted nodes associated with a predicted location of the object within an environment. In some aspects, the one or more sensors include one or more cameras (e.g., providing images 810 of FIG. 8), one or more radar sensors (e.g., providing LIDAR BEV features 850 of FIG. 8), one or more light detection and ranging (LIDAR) sensors (e.g., providing radar BEV features 850 of FIG. 8), any combination thereof, and/or other types of sensor(s).

At block 1404, the computing device (or component thereof) can receive a high definition (HD) map including a plurality of HD nodes associated with a HD location of the object within the environment. In some aspects, the HD map is based on positioning sensor data obtained from one or more positioning sensors associated with the object (e.g., the HD map 890 of FIG. 8). In some cases, the one or more positioning sensors includes one or more satellite receivers, one or more inertial measurement units (IMUs) (e.g., accelerometers, gyroscopes, and/or other type(s) of IMU(s)), a combination thereof, and/or other types of positioning sensor(s). In some examples, the HD map includes vectorized representations of the environment (e.g., as shown in FIG. 7, FIG. 8, FIG. 9, and/or FIG. 10).

At block 1406, the computing device (or component thereof) can match at least one of the plurality of predicted nodes with at least one of the plurality of HD nodes to determine one or more pairs of matched nodes between the predicted map and the HD map. Referring to FIG. 8 as an illustrative example, the object (e.g., vehicle) can match nodes (predicted nodes) from the predicted map 880 with nodes (HD nodes) from the HD map 890 to form pairs of nodes (e.g., pairs of matched nodes). For instance, the object (e.g., vehicle) can form a pair of matched nodes including one predicted node from the predicted map 880 and one HD node from the HD map 890. In some aspects, the computing device (or component thereof) can match at least one of the plurality of predicted nodes with at least one of the plurality of HD nodes using a machine learning system (e.g., a graph neural network or other type of machine learning system). Referring to FIG. 6 as an illustrative example, the machine learning system can include the neural network matching system 600.

At block 1408, the computing device (or component thereof) can determine, based on a comparison between nodes in each pair of the one or more pairs of matched nodes, a respective node score for each pair of the one or more pairs of matched nodes. In some cases, the comparison between the nodes in each pair of the one or more pairs of matched nodes is based on a displacement between the nodes in each pair of the one or more pairs of matched nodes. For instance, as described with respect to FIG. 8, when the predicted map 880 is compared (e.g., overlaid) with the HD map 890, the predicted node matched with the HD node should be overlapping with each other or in close proximity with each other with respect to their location within the environment.

At block 1410, the computing device (or component thereof) can determine, based on the respective node score for each pair of the one or more pairs of matched nodes, a location of the object within the environment. For instance, as described with respect to FIG. 8, scores (e.g., probabilities of accuracy) can be assigned to each pair of matched nodes. The computing device (or component thereof) can use the scores of the pairs of the matched nodes to determine the location of the object. In some cases, computing device (or component thereof) can perform a point level matching to determine the location of the object. For example, in a soft assignment, a strong match can be determined when a score of a pair of matched nodes is above a certain score threshold (e.g., a predetermined threshold for the score, probability). The location of the object (e.g., ego pose) can be updated (determined) by averaging the displacement between each (x,y) point between matches.

In some aspects, the predicted map includes a plurality of predicted polylines. For example, each polyline of the plurality of predicted polylines connects at least two nodes of the plurality of predicted nodes. In such aspects, the HD map can include a plurality of HD polylines, where each HD polyline of the plurality of HD polylines connects at least two HD nodes of the plurality of HD nodes. In some cases, the computing device (or component thereof) can determine a polyline score for each polyline of the plurality of predicted polylines, based on the respective node score for each pair of the one or more pairs of matched nodes that are associated with the plurality of predicted polylines. In some examples, the computing device (or component thereof) can determine the polyline score for each HD polyline of the plurality of HD polylines, based on the respective node score for each pair of the one or more pairs of matched nodes that are associated with the plurality of HD polylines. In some aspects, the computing device (or component thereof) can determine the location of the object within the environment further based on the polyline score determined for each polyline of the plurality of predicted polylines and the polyline score determined for each HD polyline for the plurality of HD polylines.

In some examples, the processes described herein (e.g., process 1400 and/or other process described herein) may be performed by a computing device or apparatus (e.g., a vehicle, such as an autonomous vehicle). In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1400 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1400 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 15 illustrates an example computing system 1500 of an example computing device which can implement the various techniques described herein. In particular, FIG. 15 illustrates an example of computing system 1500, which may be for example any computing device making up internal computing system, a remote computing system, a camera, or any component thereof in which the components of the system are in communication with each other using connection 1505. Connection 1505 may be a physical connection using a bus, or a direct connection into processor 1510, such as in a chipset architecture. Connection 1505 may also be a virtual connection, networked connection, or logical connection.

In some aspects, computing system 1500 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 may include a cache 1515 of high-speed memory connected directly with, in close proximity to, or integrated as part of processor 1510.

Processor 1510 may include any general-purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which may represent any number of input mechanisms, such as a microphone for speech, a touch-sensitive screen for gesture or graphical input, keyboard, mouse, motion input, speech, etc. Computing system 1500 may also include output device 1535, which may be one or more of a number of output mechanisms. In some instances, multimodal systems may enable a user to provide multiple types of input/output to communicate with computing system 1500.

Computing system 1500 may include communications interface 1540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug. 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 may include software services, servers, services, etc., that when the code that defines such software is executed by the processor 1510, it causes the system to perform a function. In some aspects, a hardware service that performs a particular function may include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X. Y, and Z; or that multiple processors are each tasked with a certain subset of operations X, Y, and Z such that together the multiple processors perform X, Y, and Z; or that a group of multiple processors work together to perform operations X. Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for localizing an object, the apparatus comprising: at least one memory; and at least one processor coupled to the at least one memory and configured to: generate, based on sensor data obtained from one or more sensors associated with the object, a predicted map comprising a plurality of predicted nodes associated with a predicted location of the object within an environment; receive a high definition (HD) map comprising a plurality of HD nodes associated with a HD location of the object within the environment; match at least one of the plurality of predicted nodes with at least one of the plurality of HD nodes to determine one or more pairs of matched nodes between the predicted map and the HD map; determine, based on a comparison between nodes in each pair of the one or more pairs of matched nodes, a respective node score for each pair of the one or more pairs of matched nodes; and determine, based on the respective node score for each pair of the one or more pairs of matched nodes, a location of the object within the environment.

Aspect 2. The apparatus of Aspect 1, wherein the one or more sensors comprise at least one of one or more cameras, one or more radar sensors, or one or more light detection and ranging (LIDAR) sensors.

Aspect 3. The apparatus of any one of Aspects 1 or 2, wherein the HD map is based on positioning sensor data obtained from one or more positioning sensors associated with the object.

Aspect 4. The apparatus of Aspect 3, wherein the one or more positioning sensors comprises at least one of one or more satellite receivers or one or more inertial measurement units (IMUs).

Aspect 5. The apparatus of any one of Aspects 1 to 4, wherein the at least one processor is configured to match at least one of the plurality of predicted nodes with at least one of the plurality of HD nodes using a machine learning system.

Aspect 6. The apparatus of Aspect 5, wherein the machine learning system is a graph neural network.

Aspect 7. The apparatus of any one of Aspects 1 to 6, wherein the comparison between the nodes in each pair of the one or more pairs of matched nodes is based on a displacement between the nodes in each pair of the one or more pairs of matched nodes.

Aspect 8. The apparatus of any one of Aspects 1 to 7, wherein the predicted map comprises a plurality of predicted polylines, each polyline of the plurality of predicted polylines connecting at least two nodes of the plurality of predicted nodes, and wherein the HD map comprises a plurality of HD polylines, each HD polyline of the plurality of HD polylines connecting at least two HD nodes of the plurality of HD nodes.

Aspect 9. The apparatus of Aspect 8, wherein the at least one processor is configured to: determine a polyline score for each polyline of the plurality of predicted polylines, based on the respective node score for each pair of the one or more pairs of matched nodes that are associated with the plurality of predicted polylines; and determine the polyline score for each HD polyline of the plurality of HD polylines, based on the respective node score for each pair of the one or more pairs of matched nodes that are associated with the plurality of HD polylines.

Aspect 10. The apparatus of Aspect 9, wherein the at least one processor is configured to determine the location of the object within the environment further based on the polyline score determined for each polyline of the plurality of predicted polylines and the polyline score determined for each HD polyline for the plurality of HD polylines.

Aspect 11. The apparatus of any one of Aspects 1 to 10, wherein the HD map comprises vectorized representations of the environment.

Aspect 12. The apparatus of any one of Aspects 11, wherein the object is a vehicle.

Aspect 13. A method for localizing an object, the method comprising: generating, based on sensor data obtained from one or more sensors associated with the object, a predicted map comprising a plurality of predicted nodes associated with a predicted location of the object within an environment; receiving a high definition (HD) map comprising a plurality of HD nodes associated with a HD location of the object within the environment; matching at least one of the plurality of predicted nodes with at least one of the plurality of HD nodes to determine one or more pairs of matched nodes between the predicted map and the HD map; determining, based on a comparison between nodes in each pair of the one or more pairs of matched nodes, a respective node score for each pair of the one or more pairs of matched nodes; and determining, based on the respective node score for each pair of the one or more pairs of matched nodes, a location of the object within the environment.

Aspect 14. The method of Aspect 13, wherein the one or more sensors comprise at least one of one or more cameras, one or more radar sensors, or one or more light detection and ranging (LIDAR) sensors.

Aspect 15. The method of any one of Aspects 13 or 14, wherein the HD map is generated based on positioning sensor data obtained from one or more positioning sensors associated with the object.

Aspect 16. The method of Aspect 15, wherein the one or more positioning sensors comprises at least one of one or more satellite receivers or one or more inertial measurement units (IMUs).

Aspect 17. The method of any one of Aspects 13 to 16, wherein the matching is performed using a machine learning system.

Aspect 18. The method of Aspect 17, wherein the machine learning system is a graph neural network.

Aspect 19. The method of any one of Aspects 13 to 18, wherein the comparison between the nodes in each pair of the one or more pairs of matched nodes is based on a displacement between the nodes in each pair of the one or more pairs of matched nodes.

Aspect 20. The method of any one of Aspects 13 to 19, wherein the predicted map comprises a plurality of predicted polylines, each polyline of the plurality of predicted polylines connecting at least two nodes of the plurality of predicted nodes, and wherein the HD map comprises a plurality of HD polylines, each HD polyline of the plurality of HD polylines connecting at least two HD nodes of the plurality of HD nodes.

Aspect 21. The method of Aspect 20, further comprising: determining a polyline score for each polyline of the plurality of predicted polylines, based on the respective node score for each pair of the one or more pairs of matched nodes that are associated with the plurality of predicted polylines; and determining the polyline score for each HD polyline of the plurality of HD polylines, based on the respective node score for each pair of the one or more pairs of matched nodes that are associated with the plurality of HD polylines.

Aspect 22. The method of Aspect 21, wherein determining the location of the object within the environment is further based on the polyline score determined for each polyline of the plurality of predicted polylines and the polyline score determined for each HD polyline for the plurality of HD polylines.

Aspect 23. The method of any one of Aspects 13 to 22, wherein the HD map comprises vectorized representations of the environment.

Aspect 24. The method of any one of Aspects 13 to 23, wherein the object is a vehicle.

Aspect 25. A non-transitory computer-readable storage medium comprising instructions stored thereon which, when executed by at least one processor, causes the at least one processor to perform operations according to any of 13 to 24.

Aspect 26. An apparatus for localizing an object, the apparatus including one or more means for performing operations according to any of 13 to 24.

Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.

What is claimed is:

1. An apparatus for localizing an object, the apparatus comprising:
at least one memory; and
at least one processor coupled to the at least one memory and configured to:
generate, based on sensor data obtained from one or more sensors associated with the object, a predicted map comprising a plurality of predicted nodes associated with a predicted location of the object within an environment;
receive a high definition (HD) map comprising a plurality of HD nodes associated with a HD location of the object within the environment;
match at least one of the plurality of predicted nodes with at least one of the plurality of HD nodes to determine one or more pairs of matched nodes between the predicted map and the HD map;
determine, based on a comparison between nodes in each pair of the one or more pairs of matched nodes, a respective node score for each pair of the one or more pairs of matched nodes; and
determine, based on the respective node score for each pair of the one or more pairs of matched nodes, a location of the object within the environment.

2. The apparatus of claim 1, wherein the one or more sensors comprise at least one of one or more cameras, one or more radar sensors, or one or more light detection and ranging (LIDAR) sensors.

3. The apparatus of claim 1, wherein the HD map is based on positioning sensor data obtained from one or more positioning sensors associated with the object.

4. The apparatus of claim 3, wherein the one or more positioning sensors comprises at least one of one or more satellite receivers or one or more inertial measurement units (IMUs).

5. The apparatus of claim 1, wherein the at least one processor is configured to match at least one of the plurality of predicted nodes with at least one of the plurality of HD nodes using a machine learning system.

6. The apparatus of claim 5, wherein the machine learning system is a graph neural network.

7. The apparatus of claim 1, wherein the comparison between the nodes in each pair of the one or more pairs of matched nodes is based on a displacement between the nodes in each pair of the one or more pairs of matched nodes.

8. The apparatus of claim 1, wherein the predicted map comprises a plurality of predicted polylines, each polyline of the plurality of predicted polylines connecting at least two nodes of the plurality of predicted nodes, and wherein the HD map comprises a plurality of HD polylines, each HD polyline of the plurality of HD polylines connecting at least two HD nodes of the plurality of HD nodes.

9. The apparatus of claim 8, wherein the at least one processor is configured to:
determine a polyline score for each polyline of the plurality of predicted polylines, based on the respective node score for each pair of the one or more pairs of matched nodes that are associated with the plurality of predicted polylines; and
determine the polyline score for each HD polyline of the plurality of HD polylines, based on the respective node score for each pair of the one or more pairs of matched nodes that are associated with the plurality of HD polylines.

10. The apparatus of claim 9, wherein the at least one processor is configured to determine the location of the object within the environment further based on the polyline score determined for each polyline of the plurality of predicted polylines and the polyline score determined for each HD polyline for the plurality of HD polylines.

11. The apparatus of claim 1, wherein the HD map comprises vectorized representations of the environment.

12. The apparatus of claim 1, wherein the object is a vehicle.

13. A method for localizing an object, the method comprising:
generating, based on sensor data obtained from one or more sensors associated with the object, a predicted map comprising a plurality of predicted nodes associated with a predicted location of the object within an environment;
receiving a high definition (HD) map comprising a plurality of HD nodes associated with a HD location of the object within the environment;
matching at least one of the plurality of predicted nodes with at least one of the plurality of HD nodes to determine one or more pairs of matched nodes between the predicted map and the HD map;
determining, based on a comparison between nodes in each pair of the one or more pairs of matched nodes, a respective node score for each pair of the one or more pairs of matched nodes; and
determining, based on the respective node score for each pair of the one or more pairs of matched nodes, a location of the object within the environment.

14. The method of claim 13, wherein the one or more sensors comprise at least one of one or more cameras, one or more radar sensors, or one or more light detection and ranging (LIDAR) sensors.

15. The method of claim 13, wherein the HD map is generated based on positioning sensor data obtained from one or more positioning sensors associated with the object.

16. The method of claim 15, wherein the one or more positioning sensors comprises at least one of one or more satellite receivers or one or more inertial measurement units (IMUs).

17. The method of claim 13, wherein the matching is performed using a machine learning system.

18. The method of claim 17, wherein the machine learning system is a graph neural network.

19. The method of claim 13, wherein the comparison between the nodes in each pair of the one or more pairs of matched nodes is based on a displacement between the nodes in each pair of the one or more pairs of matched nodes.

20. The method of claim 13, wherein the predicted map comprises a plurality of predicted polylines, each polyline of the plurality of predicted polylines connecting at least two nodes of the plurality of predicted nodes, and wherein the HD map comprises a plurality of HD polylines, each HD polyline of the plurality of HD polylines connecting at least two HD nodes of the plurality of HD nodes.

21. The method of claim 20, further comprising:
determining a polyline score for each polyline of the plurality of predicted polylines, based on the respective node score for each pair of the one or more pairs of matched nodes that are associated with the plurality of predicted polylines; and
determining the polyline score for each HD polyline of the plurality of HD polylines, based on the respective node score for each pair of the one or more pairs of matched nodes that are associated with the plurality of HD polylines.

22. The method of claim 21, wherein determining the location of the object within the environment is further based on the polyline score determined for each polyline of the plurality of predicted polylines and the polyline score determined for each HD polyline for the plurality of HD polylines.

23. The method of claim 13, wherein the HD map comprises vectorized representations of the environment.

24. The method of claim 13, wherein the object is a vehicle.

25. A non-transitory computer-readable storage medium comprising instructions stored thereon which, when executed by at least one processor, causes the at least one processor to:
generate, based on sensor data obtained from one or more sensors associated with an object, a predicted map comprising a plurality of predicted nodes associated with a predicted location of the object within an environment;
receive a high definition (HD) map comprising a plurality of HD nodes associated with a HD location of the object within the environment;
match at least one of the plurality of predicted nodes with at least one of the plurality of HD nodes to determine one or more pairs of matched nodes between the predicted map and the HD map;
determine, based on a comparison between nodes in each pair of the one or more pairs of matched nodes, a respective node score for each pair of the one or more pairs of matched nodes; and
determine, based on the respective node score for each pair of the one or more pairs of matched nodes, a location of the object within the environment.

26. The non-transitory computer-readable storage medium of claim 25, wherein the HD map is generated based on positioning sensor data obtained from one or more positioning sensors associated with the object.

27. The non-transitory computer-readable storage medium of claim 25, wherein the comparison between the nodes in each pair of the one or more pairs of matched nodes is based on a displacement between the nodes in each pair of the one or more pairs of matched nodes.

28. The non-transitory computer-readable storage medium of claim 25, wherein the predicted map comprises a plurality of predicted polylines, each polyline of the plurality of predicted polylines connecting at least two nodes of the plurality of predicted nodes, and wherein the HD map comprises a plurality of HD polylines, each HD polyline of the plurality of HD polylines connecting at least two HD nodes of the plurality of HD nodes.

29. The non-transitory computer-readable storage medium of claim 28, further comprising:
determining a polyline score for each polyline of the plurality of predicted polylines, based on the respective node score for each pair of the one or more pairs of matched nodes that are associated with the plurality of predicted polylines; and
determining the polyline score for each HD polyline of the plurality of HD polylines, based on the respective node score for each pair of the one or more pairs of matched nodes that are associated with the plurality of HD polylines.

30. The non-transitory computer-readable storage medium of claim 29, wherein determining the location of the object within the environment is further based on the polyline score determined for each polyline of the plurality of predicted polylines and the polyline score determined for each HD polyline for the plurality of HD polylines.
